(19) United States
(12) Patent Application Publication
(10) Pub. No.: US 2015/0310116 A1
(43) Pub. Date: Oct. 29, 2015

(54) PROVIDING SEARCH RESULTS CORRESPONDING TO DISPLAYED CONTENT

(71) Applicant: Alibaba Group Holding Limited, George Town (KY)

(72) Inventor: Di Fan, Hangzhou (CN)

(21) Appl. No.: 14/691,122

(22) Filed: Apr. 20, 2015

(30) Foreign Application Priority Data
Apr. 29, 2014 (CN) 201410177908.X

(51) Int. Cl. G06F 17/30

(52) U.S. Cl. CPC G06F 17/30867; G06F 17/3053

(57) ABSTRACT

Providing search results corresponding to displayed content is disclosed, including: receiving a search command associated with a selected piece of displayed content, wherein the displayed content is presented at a user interface; determining a search query from the selected piece of displayed content; determining a plurality of target search categories associated with the search query; performing a respective search using the search query in each target search category of the plurality of target search categories to obtain a corresponding set of one or more search results; and causing the corresponding set of one or more search results obtained for each target search category of the plurality of target search categories to be presented in a corresponding section associated with that target search category in a separate window at the user interface.

### CROSS REFERENCE TO OTHER APPLICATIONS

This application claims priority to People's Republic of China Patent Application No. 201410177908.X entitled A METHOD AND A DEVICE FOR PRESENTING SEARCH RESULTS, filed Apr. 29, 2014 which is incorporated herein by reference for all purposes.

### FIELD OF THE INVENTION

The present application relates to a field of information searching. In particular, the present application relates to techniques for presenting search results.

### BACKGROUND OF THE INVENTION

Search engines have become a primary means whereby users acquire information through the Internet. Existing search engines generally provide users with a search page to begin their searches. To search for information, the user enters a search term in the search term input box of the search page. The search engine acquires this search term from the search term input box, searches for search results that match this search term, and obtains the search results that match this search term. The search engine then presents the matching search results on the search page. The search page can be provided in a browser or in a client application, for example.

Many search engines provide users the option to limit their search to one or more particular categories to help users quickly find the search results they need. For example, the search engine can provide the user many different search categories and the user can select those search categories that the user wishes to perform a search in. Then, when the search engine performs a search using a search term, the search engine will match the search term to search results in only the user-selected search categories. As a result, the search engine will present only the search results that were found in the user-selected search categories. Thus, searches are done more accurately and efficiently because only the user-selected search categories are searched for results. Searching only in user-selected search categories also reduces the quantity of search results that the user will need to review.

In many cases, when a user sees an interesting piece of content (e.g., a piece of text, an image, etc.) on a webpage or an application that is presented on a display interface, he or she may wish to use that piece of content as a search term to retrieve search results. Conventionally, the user can copy and paste the piece of content from the presented webpage into the search term input box of a search page of a search engine and also select a desired search category in which to perform a search. If the user wishes to perform the search in multiple different search categories, then, conventionally, the user needs to perform several searches with the piece of content, where each search is performed in a different search category and the search results obtained by searching through each different search category are presented at a separate search page. As such, conventionally, to perform a search using a piece of content from a webpage or an application, a user would need to manually copy the piece of content into the search term input box of a search engine and perform individual searches for each search category that the user wishes to search in. This procedure is both cumbersome for the user and inefficient for the search engine as it requires the search engine to execute multiple searches and to generate presentations for the same search term in response to multiple search requests.

### BRIEF DESCRIPTION OF THE DRAWINGS

Various embodiments of the invention are disclosed in the following detailed description and the accompanying drawings.

FIG. 1 is a diagram showing an embodiment of a system for providing search results corresponding to displayed content.

FIG. 2 is a flow diagram showing an embodiment of a process for providing search results corresponding to displayed content.

FIG. 3 shows a diagram of a conventional menu window that is presented in response to a user's selection of a right-click on an input device.

FIG. 4 shows a diagram of a first example of a separate window that presents search results from various target search categories.

FIG. 5 shows a diagram of a second example of a separate window that presents search results from various target search categories.

FIG. 6 is a diagram showing an embodiment of a system for providing search results corresponding to displayed content.

FIG. 7 is a diagram showing a first example of a category determining module.

FIG. 8 is a diagram showing a second example of a category determining module.

FIG. 9 is a diagram showing a third example of a category determining module.

FIG. 10 is a diagram showing an example of a results presenting module.

FIG. 11 is a diagram showing an embodiment of a system for providing search results corresponding to displayed content.

FIG. 12 is a functional diagram illustrating an embodiment of a programmed computer system for providing search results corresponding to displayed content.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of providing search results corresponding to displayed content are described herein. A search command associated with a selected piece of displayed content is received. The displayed content is presented at a user interface. A search query is determined from the selected piece of displayed content. The search query comprises text and/or images, for example. A plurality of target search categories associated with the search query is determined. A search is performed in each of the plurality of target search categories using the search query to determine a set of search results corresponding to that search query. The set of search results corresponding to each target search category is simultaneously presented in a corresponding section of a separate window that is presented over the user interface.

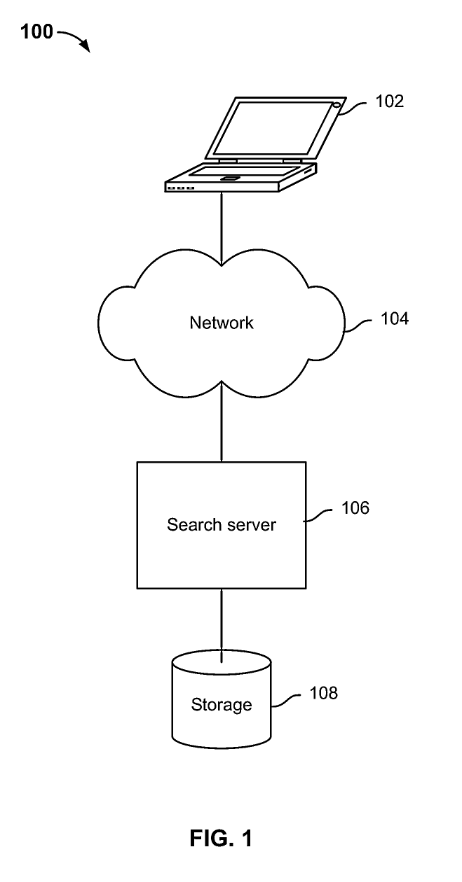

FIG. 1 is a diagram showing an embodiment of a system for providing search results corresponding to displayed content. In the example, system 100 includes client device 102, network 104, search server 106, and storage 108. Network 104 includes high-speed data networks, high-speed telecommunications networks, and/or any other appropriate types of networks.

A user can interact with a user interface using client device 102. In various embodiments, the user interface comprises a document that is presented by a viewer application. Examples of the viewer application comprise a word processing application, a Portable Document File (PDF) reader application, and a web browser application. In various embodiments, in the event that the user wishes to perform a search using a portion of the content that is presented at the user interface, the user can select the piece of displayed content and perform a predetermined operation associated with the causing a search to be performed with respect to the selected piece of displayed content. For example, the user can use an input device (e.g., a computer mouse, a touchscreen, an input pad) to first highlight the piece of the displayed content and then to simultaneously select the right-click on the input device and press down on the “CTRL” key on a keyboard to trigger a search to be performed with respect to the selected piece of displayed content. In some embodiments, a component of the viewer application detects the user selection of the piece of displayed content and the subsequent simultaneous selection of the input device and the key on the keyboard. After such detection, the viewer application can trigger the search to be performed with respect to the selected piece of displayed content. In response to the user's performance of the predetermined operation, client device 102 is configured to generate a search command associated with the selected piece of displayed content and to send the search command to search server 106 over network 104.

Search server 106 is configured to receive the search command and to determine a search query from the selected piece of displayed content. In some embodiments, search server 106 is associated with operating a search engine. For example, search server 106 is configured to determine the search query by extracting the text and/or image(s) from the selected piece of displayed content. Search server 106 is configured to determine a plurality of target search categories associated with the search query. As will be described in further detail below, search server 106 is configured to access data stored at storage 108 to determine the plurality of target search categories associated with the search query. For example, storage 108 is configured to store one or more of historical user behavior data and/or search category configurations submitted by users. Search server 106 is configured to search each target search category using the search query to determine a corresponding set of search results. Search server 106 is configured to cause a separate window with the search results associated with the target search categories to be presented over the user interface displayed by client device 102. In some embodiments, the separate window comprises a floating window that is overlaid over the user interface. In various embodiments, search server 106 is configured to send the data associated with rendering the separate window to client device 102 so that client device 102 can present the separate window at the user interface. In various embodiments, the separate window includes a corresponding section for each target search category, where the section for each target search category presents the search results found in that target search category.

Various embodiments as described herein enable a user to easily trigger a search associated with selected content that is presented at a user interface. Various embodiments as described herein also enable a user to conveniently view the search results associated with the selected content from across multiple target categories in a single presentation of a separate window without needing to navigate away from the original user interface.

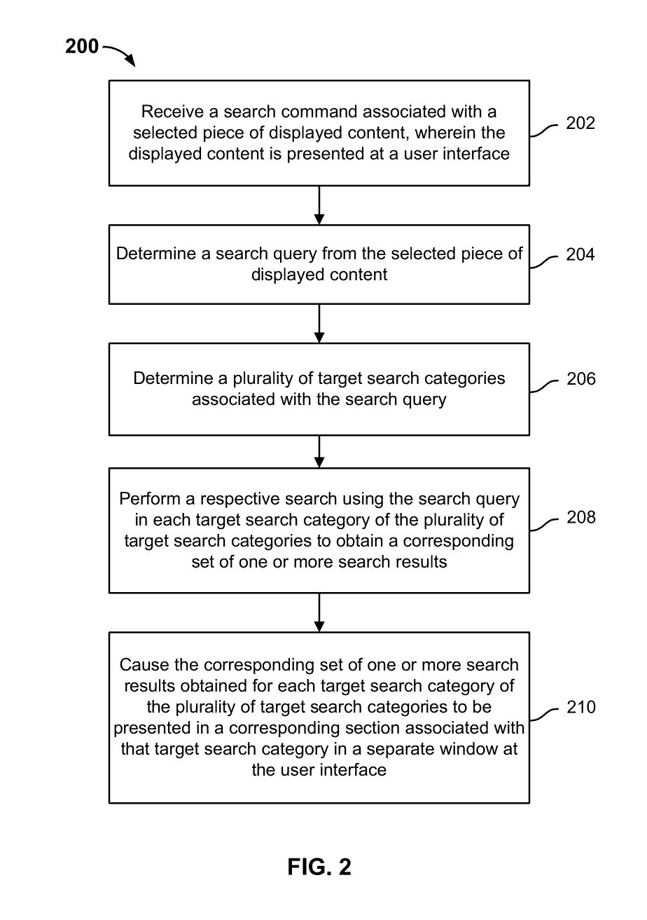

FIG. 2 is a flow diagram showing an embodiment of a process for providing search results corresponding to displayed content. In some embodiments, process 200 is implemented at system 100 of FIG. 1.

At 202, a search command associated with a selected piece of displayed content is received, wherein the displayed content is presented at a user interface.

Various types of content can be presented at a user interface of a device. Some examples of the content include text and/or images. Some examples of viewer applications that can present the content include a word processing application, a Portable Document File (PDF) reader application, and a web browser application.

As the user views the displayed content, he or she may be interested in receiving more information regarding a piece of the displayed content. In various embodiments, the user can then select this piece of the displayed content and perform a predetermined operation to cause a search to be performed using the selected portion of the displayed content. In various embodiments, the selected piece of displayed content comprises text, image(s), or both. For example, the user can select the piece of the displayed content by using an input device (e.g., a computer mouse, a touchscreen, and/or an input pad) to highlight the piece of text and/or image among the displayed content. In various embodiments, one or more operations that are each configured to trigger a search to be performed with respect to a selected piece of displayed content are predetermined. In some embodiments, a predetermined operation comprises a user selecting a predetermined physical key and or simultaneously selecting multiple predetermined physical keys on one or more input devices. For example, a predetermined operation comprises a user simultaneously selecting the right-click on a computer mouse and pressing down on the “CTRL” key on a keyboard. After a piece of displayed content has been selected, the performance by a user of such a predetermined operation is configured to cause a search to be performed with respect to a selected piece of displayed content. In some embodiments, causing the search to be performed with respect to the selected piece of displayed content comprises using the selected piece of displayed content as a search query and sending the search query to a server (e.g., associated with a search engine) to conduct the search. In various embodiments, the user that has performed the predetermined operation that caused the search to be performed is referred to as the “current searching user.”

At 204, a search query is determined from the selected piece of displayed content.

As described above, the selected piece of displayed content comprises text, image(s), or both. The text and/or one or more images from the selected piece of displayed content are extracted and determined as a search query. If the selected piece of displayed content included text, then each phrase or word included in the text forms a search term within the search query.

At 206, a plurality of target search categories associated with the search query is determined.

Generally, there could be many search categories in which the search query may be searched. In various embodiments, a search category comprises a category of information. In various embodiments, instead of searching across all search categories, a search with the search query is to be performed in only a subset of search categories, referred to as “target search categories.” By performing a search in particular one or more target search categories, only the matching information from those one or more target search categories and not the matching information from search categories other than the target search categories will be returned as search results. Searching in only target search categories (as opposed to searching across all search categories) can limit the scope of search and therefore, decrease the amount of time the search will take. Searching in only target search categories can also limit the amount of search results that need to be returned, which is efficient for presenting search results.

In various embodiments, the search results corresponding to each target search category in which a search is to be performed are to be presented in a separate window in the user interface and as such, the amount of search results that can be presented in this manner is limited. For example, as will be described below, the search results corresponding to each target search category in which a search is to be performed are to be presented in a corresponding section of a separate window that is in the form of a right-click menu. Therefore, a maximum number of target search categories is selected such that the search results corresponding to all the target search categories that are to be presented in the separate window will not exceed the available display dimensions associated with the separate window. In some embodiments, the maximum quantity of target search categories is selected based on the predetermined maximum available display dimensions associated with the separate window.

The target search categories associated with the search query can be determined using various techniques. Below are some examples of such techniques:

In a first example, the target search categories associated with the search query are determined based on the current searching user's own search history. In some embodiments, the current searching user can be identified from user identifying information that is included in the search command. For example, the current searching user's historical search operations have been recorded in historical user behavior data. In some embodiments, historical user behavior data is stored as logs on a server, the current searching user's own device, or both. Historical user behavior data associated with the current searching user indicates previous search queries submitted by the current searching user, the one or more search categories that were selected by the current searching user to use to search in each of the search queries, any search results that were selected by the current searching user in each of such search categories, and/or any other appropriate log information. The historical user behavior data associated with the current searching user can be retrieved from storage (e.g., a log file on the server) and the number of search operations that were performed by the current searching user with respect to each search category is counted. Examples of a search operation with respect to a search category includes the selection by the current searching user to perform a search in that search category and the current searching user's selection of a search result that was found in that search category. The number of search operations that were performed in a search category by the current searching user is used to represent the degree of the current searching user's interest in that search category. For example, the search categories can be ranked by their respective number of search operations historically performed by the current searching user. For example, a predetermined N number of target search categories associated with the current search query can be selected from the highest ranking historical search categories. As such, the search categories associated with the highest degrees of the current searching user's interest can be selected as the target search categories associated with the current search query.

In a second example, the target search categories associated with the search query are determined based on the search histories of additional users, not just the current searching user's own search history. For example, the historical search histories of all users of the search engine, including the current searching user, can be used. For example, each user's historical search operations have been recorded in historical user behavior data. Historical user behavior data associated with each user indicates previous search queries submitted by that user, the one or more search categories that were selected by that user to use to search in for each of such search queries, and any search results that were selected by that user in each of the search categories. The historical user behavior data associated with each user can be retrieved from storage and the number of search operations that were performed by all users with respect to each search category is counted. Examples of a search operation with respect to a search category includes the selection by a user to perform a search in that search category and the user's selection of a search result that was found in that search category. The number of search operations that were performed in a search category by all users is used to represent the degree of overall user interest in that search category. For example, the search categories can be ranked by the respective number of search operations. For example, a predetermined N number of target search categories associated with the current search query can be selected from the highest ranking historical search categories. As such, the search categories associated with the highest degrees of overall user interest can be selected as the target search categories associated with the current search query.

In a third example, the target search categories associated with the search query comprise categories that were preset by the current searching user. For example, prior to a performance of process 200, the current searching user had submitted, using the client device, to the search engine configurations associated with one or more search categories that he or she frequently uses. As such, these search categories that were preset by the current searching user in advance can be used as the target search categories in which to perform searches for a search query determined from a search command that is subsequently triggered by the current searching user. For example, the current searching user sets his operating system and search engine in a language other than Chinese but regularly prefers to search for the Chinese-language explanation/translation of displayed content. Therefore, the current searching user may set the “Chinese-language translation” search category as a preset search category so that, in the future, whenever the user triggers the search command for conducting a search in relation to a piece of displayed content, a search for the piece of displayed content will be performed in the “Chinese-language translation” search category, and the search results obtained from the “Chinese-language translation” search category are obtained and displayed in the separate window at the user interface. Each user's preset search categories can be recorded in connection with the user's user identifying information so that the target search categories for the current searching user can be looked up using the user identifying information associated with the current searching user in response to a search command associated with the current searching user. In some embodiments, the current searching user can be identified from user identifying information that is included in the search command. Examples of user identifying information include one or more of the following: information associated with a user's account, a user identifier, and other information indicating the user's user identity at the search engine.

In a fourth example, the target search categories associated with the search query are determined according to the meaning expressed by the context content that is presented with the selected piece of displayed content. The context of the selected piece of displayed content comprises the text and/or images that are nearby the selected piece of displayed content. For example, the following text is presented at a user interface: “It will be Christmas in a few days. Have you bought a present yet?” In this example, the current user that is viewing the user interface selects the text “Christmas” and then triggers a predetermined operation associated with triggering a search command with respect to the search query “Christmas.” Then, the context content nearby the search query “Christmas” (that is, text surrounding and including the word “Christmas”) is segmented into individual words or phrases. In the example, the context content relative to the search query “Christmas” includes at least some portion of the sentence “It will be Christmas in a few days. Have you bought a present yet?” The segmented words/phrases can be used in several techniques to obtain target search categories. In one example technique, among the segmented words/phrases, nouns are kept for purposes of category matching and other words are discarded. In another example technique, segmented words/phrases in a fixed window surrounding the selected piece of displayed content are used to find matching search categories. Search categories that are associated with (e.g., the strings matched with) at least some of the segmented words/phrases can be used as the target search categories for the search query. In this example, “Christmas present” can be determined as a target search category for the search query “Christmas” based on the segmented context content word of “present” or a combination of “Christmas” and “present.” In the example, “present” itself could have also been determined as a target for the search query “Christmas” based on the segmented context content word of “present.”

In some embodiments, determination of target search categories associated with the search query can be performed based on one or a combination of multiple example techniques that are described above. For example, some of the target search categories may comprise at least some of the search categories that were preset by the current searching user and some other of the target search categories may be determined according to the meaning expressed by the context content that is presented with the selected piece of displayed content. Furthermore, for example, any remaining target search categories (up to the maximum number of target search categories) may comprise the search categories that are associated with the greatest degrees of overall user interest.

At 208, a respective search is performed using the search query in each target search category of the plurality of target search categories to obtain a corresponding set of one or more search results.

The search query is used to perform a separate search in each target search category of the plurality of target search categories with the search query. In various embodiments, performing a search using the search query in a target search category includes finding search results in that target search category that match the search query. Zero or more search results may be found to match the search query in each target search category of the plurality of target search categories.

At 210, the corresponding set of one or more search results obtained for each target search category of the plurality of target search categories is caused to be presented in a corresponding section associated with that target search category in a separate window at the user interface.

The search results obtained by searching using the search query in each target search category are presented in a separate window at the user interface. In various embodiments, the data associated with rendering the separate window is sent to the client device from which the search command was received. In particular, the search results obtained from each target search category are presented in a separate section of the separate window corresponding to that target search category. In various embodiments, a search result found in a target search category comprises a piece of information that may comprise a hyperlink to a webpage, a hyperlink to downloadable content, and/or other types of information.

In various embodiments, the “separate window” comprises a window that overlays the user interface at which the selected piece of displayed content was presented. In some embodiments, a separate window is implemented by a procedure invoked by the operating system. In some embodiments, the dimensions of the separate window are smaller than the dimensions of the user interface over which the separate window is displayed. By presenting a separate window that is smaller than the user interface it is presented over, the current searching user can view the search results in a manner that does not require the current searching user to navigate away from the original user interface. This way, the current searching user can view the search results from the various target search categories simultaneously with the original content of the user interface, including the selected piece of displayed content.

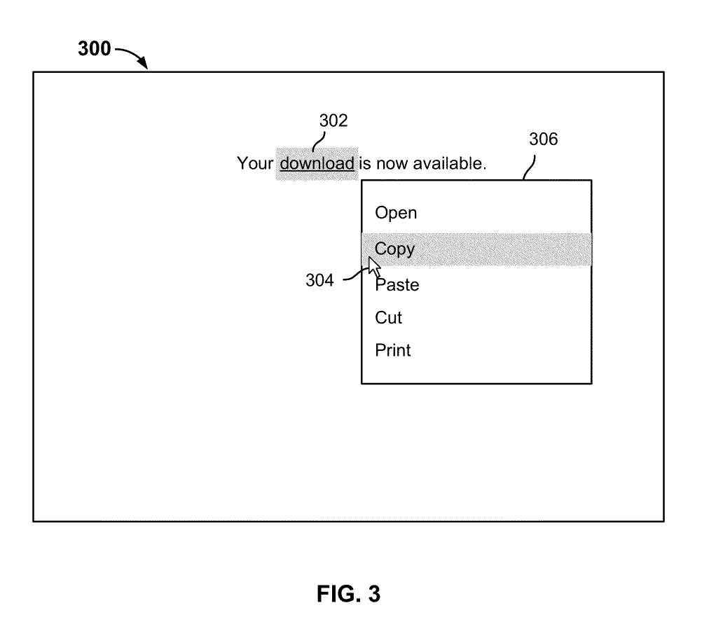

In some embodiments, the appearance of and the organization of content in a “separate window” is similar to the appearance of and the organization of content in a menu window that is presented in response to a specific user operation. In one example, the “separate window” is similar to a menu window that is presented in response to a user's selection of a right-click on an input device. FIG. 3 shows a diagram of a conventional menu window that is presented in response to a user's selection of a right-click on an input device. In the example of FIG. 3, user interface 300 comprises a webpage that presents the following text content: “Your download is now available.” As shown in the diagram, a user has controlled cursor 304 using an input device (e.g., a computer mouse or a mouse pad) to select piece of displayed content 302, which includes the hyperlink and associated text of “download.” Furthermore, the user has selected the right-click of the input device, which caused right-click menu window 306 to be presented over user interface 300. Right-click menu window 306 presents various operations that the user can select and to cause the selected operation(s) to be performed with respect to the selected piece of displayed content 302 and/or all the content displayed at the user interface. In the example, the operations presented in right-click menu window 306 include “Open,” “Copy,” “Paste,” “Cut,” and “Print.”

Returning to step 210 of process 200 of FIG. 2, in some embodiments, the separate window comprises a menu window that is presented in response to a user's selection of a right-click on an input device, where the search results found in each target search category are presented in a separate section of the menu window associated with the respective target search category. For example, the one or more search results found in Target Search Category A are presented in the section of the separate window that is associated with Target Search Category A and the one or more search results found in Target Search Category B are presented in the section of the separate window that is associated with Target Search Category B. As such, while the search results corresponding to different target search categories are simultaneously presented in the separate window, the search results are classified into their respective target search categories.

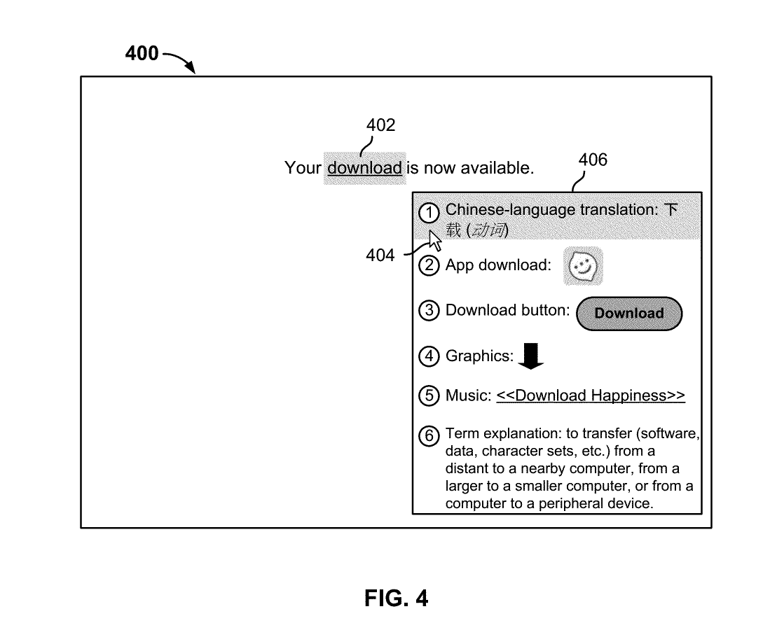

FIG. 4 shows a diagram of a first example of a separate window that presents search results from various target search categories. In the example of FIG. 4, user interface 400 comprises a webpage that presents the following text content: “Your download is now available.” As shown in the diagram, a user has controlled cursor 404 using an input device (e.g., a computer mouse or a mouse pad) to select piece of displayed content 402, which includes the hyperlink and associated text of “download.” Furthermore, the user has performed a selection associated with triggering a search command (e.g., selected the right-click of the input device) with respect to selected piece of displayed content 402, which invokes a function in response to the right-click, and the function in turn causes separate window 406 to be presented. Separate window 406 shows six sections associated with six respective target search categories, labeled with \textcircled{1} through \textcircled{6}. The search categories can be determined according to any of the techniques described above in connection with FIG. 2. Each section of separate window 406 is associated with a corresponding target search category and also includes a search result found in that target search category. In the example of FIG. 4, the first target search category (and the one that cursor 404 is currently hovering over) is the “Chinese-language translation” search category and includes a search result that describes in Chinese the search query that is determined from the selected piece of displayed content 402. The second target search category is the “App download” search category and includes a search result that comprises an image that links to a download of an app that is found based on comparing the search query determined from selected piece of displayed content 402 to a database of apps (e.g., an app whose title includes “download”). The third target search category is the “Download” search category and includes a search result that comprises an image of a button that is found based on comparing the search query determined from selected piece of displayed content 402 to a database of button images. The fourth target search category is the “Graphics” search category and includes a search result that comprises an image of an arrow that is found based on comparing the search query determined from selected piece of displayed content 402 to a database of graphics. The fifth target search category is the “Music” search category and includes a search result that comprises a hyperlink that links to a download of a song called “Download Happiness” that is found based on comparing the search query determined from selected piece of displayed content 402 to a database of song titles. The sixth target search category is the “Term explanation” search category and includes a search result that comprises an explanation of the search query determined from selected piece of displayed content 402 based on searching through an information source (e.g., a dictionary).

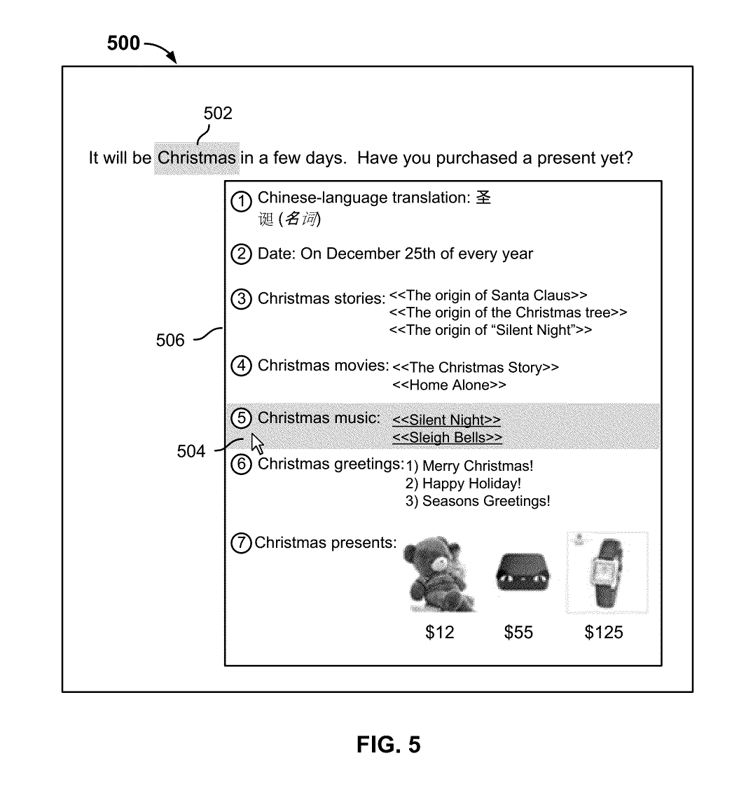

FIG. 5 shows a diagram of a second example of a separate window that presents search results from various target search categories. In the example of FIG. 5, user interface 500 comprises a webpage that presents the following text content: “It will be Christmas in a few days. Have you purchased a present yet?” As shown in the diagram, a user has controlled cursor 504 using an input device (e.g., a computer mouse or a mouse pad) to select piece of displayed content 502, which includes the text of “Christmas.” Furthermore, the user has performed a selection associated with triggering a search command (e.g., selected the right-click of the input device) with respect to selected piece of displayed content 502, which invokes a function in response to the right-click, and the function in turn causes separate window 506 to be presented. Separate window 506 shows seven sections associated with seven respective target search categories, labeled with \textcircled{1} through \textcircled{7}. The search categories can be determined according to any of the techniques described above in connection with FIG. 2. Each section of separate window 506 is associated with a corresponding target search category and also includes one or more search results found in that target search category. In the example of FIG. 5, the first target search category is the “Chinese-language translation” search category and includes a search result that describes in Chinese the search query that is determined from the selected piece of displayed content 502. The second target search category is the “Date” search category and includes a search result that comprises a piece of information that is found based on comparing the search query determined from selected piece of displayed content 502 to a database of dates of holidays. The third target search category is the “Christmas stories” search category and includes multiple search results that comprise titles of stories found based on comparing the search query determined from selected piece of displayed content 502 to a database of stories. The fourth target search category is the “Christmas movies” search category and includes multiple search results that comprise titles of movies that are found based on comparing the search query determined from selected piece of displayed content 502 to a database of movie titles. The fifth target search category (and the one that cursor 504 is currently hovering over) is the “Christmas music” search category and includes multiple search results that comprise song titles that are each linked to a download of a corresponding song that are found based on comparing the search query determined from selected piece of displayed content 502 to a database of song titles. The sixth target search category is the “Christmas greetings” search category and includes multiple search results that comprise greetings that are determined based on comparing the search query determined from selected piece of displayed content 502 to a database of greetings. The seventh target search category is the “Christmas presents” search category and includes multiple search results that comprise images that are each linked to a webpage at which the corresponding product can be purchased and that are determined based on comparing the search query determined from selected piece of displayed content 502 to a database of products.

Returning to step 210 of process 200 of FIG. 2, the display space in the sections for presenting search results in a separate window is limited and therefore, the number of search results in each target search category that can be presented in the separate window is also limited. In some embodiments, an appropriate number of search results that can be presented with each target search category in the separate window is determined such that the total number of search results presented in the separate window will not exceed the maximum quantity of presentation information that the separate window can present. For example, the maximum quantity of presentation information that the separate window can present may be a maximum number of search results across all the target search categories or may be the maximum display dimensions of the space in which the search results can be presented in the separate window. In some embodiments, the number of search results to display with each target search category is determined based on historical user behavior data. For example, the historical search histories of all users of the search engine, including the current searching user, can be used. For example, each user's historical search operations have been recorded in historical user behavior data. Historical user behavior data associated with each user indicates previous search queries submitted by that user, the one or more search categories that were selected by that user to use to search in for each of such search queries, and any search results that were selected by that user in each of the search categories. The historical user behavior data associated with each user can be retrieved from storage and the number of search operations that were performed by all users with respect to search results of each target search category is counted. Examples of a search operation with respect to a target search category include the selection by a user to perform a search in that target search category and the user's selection of a search result that was found in that target search category. The number of search operations that were performed by all users with respect to search results in a target search category is used to represent the degree of overall user interest in search results of that target search category. For example, the search categories can be ranked by the respective number of search operations. For example, a corresponding predetermined number of search results that can be presented for each target search category can be determined from the ranking of the target search categories, such that more search results can be presented from a target search category that has a higher count of search operations and fewer search results can be presented from a target search category that has a fewer count of search operations. The total number of search results to be presented across all the target search categories should be equal to or less than the maximum quantity of presentation information that the separate window can present, for example.

In various embodiments, because the number of search results that can be presented in the corresponding section of each target search category in the separate window is limited, a user may perform a view additional search results command with respect to a target search category in the separate window to cause a new window (e.g., or a new tab) to be opened by the viewer application (e.g., a browser application) so that the new window can display a larger search page with additional search results from that target search category. For example, the view additional search results command with respect to a target search category comprises a user selection of the corresponding section of that target search category in the separate window.

In various embodiments, in the event that a search result presented in the corresponding section of a target search category in the separate window comprises a hyperlink (e.g., a Web link), a user can access the hyperlinked address by selecting on that search result. In response to the user selection of a search result that comprises a hyperlink, the viewer application invokes a function to open a new window (e.g., or a new tab) to download content from that hyperlinked address. For example, returning to the example of FIG. 4, the search result from the “Music” target search category comprises a hyperlink associated with the downloadable song “Download Happiness.” When a user clicks on the “Download Happiness” search result, the selection will trigger the corresponding download software to execute downloading of the audio file from the hyperlinked address.

Process 200 as described above allows the concurrent presentation of search results across many search categories in response to a single search command with respect to a selected piece of displayed content. The search results can be presented in a separate window that overlays the same user interface at which the user had made the initial selection associated with the search command, thereby allowing the user to simultaneously view the selected displayed content and also the search results associated with the selected displayed content in various search categories.

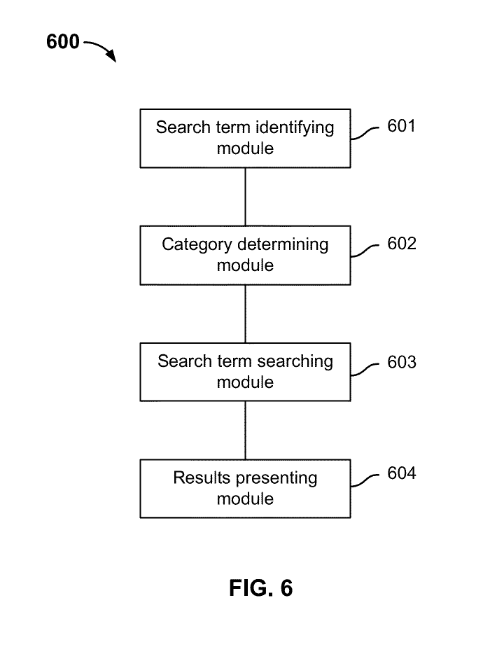

FIG. 6 is a diagram showing an embodiment of a system for providing search results corresponding to displayed content. In the example, system 600 includes search term identifying module 601, category determining module 602, search term searching module 603, and results presenting module 604.

The modules can be implemented as software components executing on one or more processors, as hardware such as programmable logic devices, and/or Application Specific Integrated Circuits designed to elements that can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices.

Search term identifying module 601 is configured to receive a search command associated with a selected piece of displayed content. The displayed content is presented at a user interface. The search command is generated in response to a predetermined operation performed by a current searching user. Search term identifying module 601 is configured to determine a search query from the selected piece of displayed content.

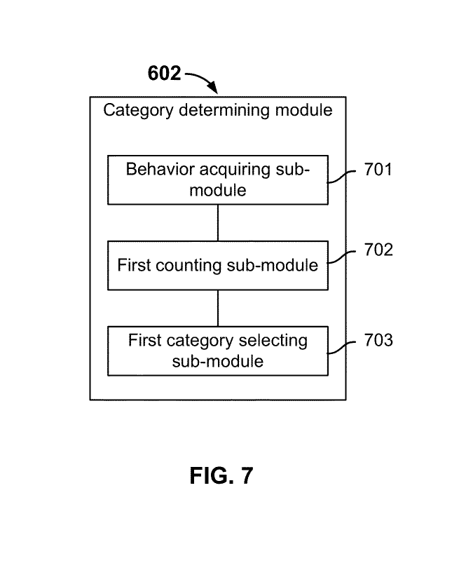

Category determining module 602 is configured to determine a plurality of target search categories associated with the search query. Examples of category determining module 602 are described in FIGS. 7, 8, and 9, below.

Search term searching module 603 is configured to perform a respective search using the search query in each target search category of the plurality of target search categories to obtain a corresponding set of one or more search results.

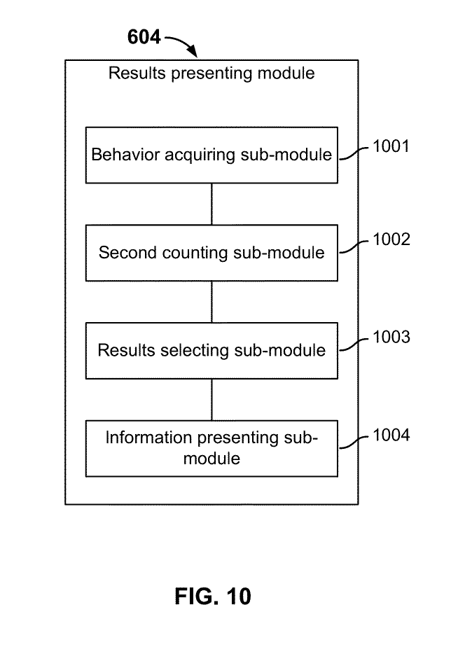

Results presenting module 604 is configured to present the corresponding set of one or more search results obtained for each target search category of the plurality of target search categories in a corresponding section associated with that target search category in a separate window at the user interface. An example of results presenting module 604 is described with FIG. 10, below.

FIG. 7 is a diagram showing a first example of a category determining module. In some embodiments, category determining module 602 of system 600 of FIG. 6 is implemented using the example of FIG. 7. In the example, the category determining module includes behavior acquiring sub-module 701, first counting sub-module 702, and first category selecting sub-module 703.

The sub-modules can be implemented as software components executing on one or more processors, as hardware such as programmable logic devices, and/or Application Specific Integrated Circuits designed to elements that can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The sub-modules may be implemented on a single device or distributed across multiple devices.

Behavior acquiring sub-module 701 is configured to obtain user behavior data including recorded user operations in user search histories.

First counting sub-module 702 is configured to use the user behavior data to count the number of user search operations in each historically searched search category. In some embodiments, the number of user search operations in each historically searched search category comprises the number of user search operations that were performed by all users in that search category. In some embodiments, the number of user search operations in each historically searched search category comprises the number of user search operations that were performed by the current searching user in that search category.

First category selecting sub-module 703 is configured to rank the historically searched search categories by their respective counts of user search operations and to select a portion of the historically searched search categories associated with the highest rankings to use as the target search categories.

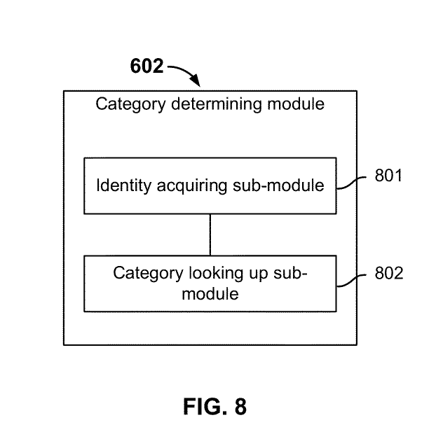

FIG. 8 is a diagram showing a second example of a category determining module. In some embodiments, category determining module 602 of system 600 of FIG. 6 is implemented using the example of FIG. 8. In the example, the category determining module includes identity acquiring sub-module 801 and category looking up sub-module 802.

The sub-modules can be implemented as software components executing on one or more processors, as hardware such as programmable logic devices, and/or Application Specific Integrated Circuits designed to elements that can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The sub-modules may be implemented on a single device or distributed across multiple devices.

Identity acquiring sub-module 801 is configured to obtain the user identity information of the current searching user. In some embodiments, the user identity information of the current searching user is included in the search command.

Category looking up sub-module 802 is configured to look up among stored preset search categories for those preset search categories that are associated with the obtained user identity information of the current searching user. The looked up preset search categories are used as target search categories.

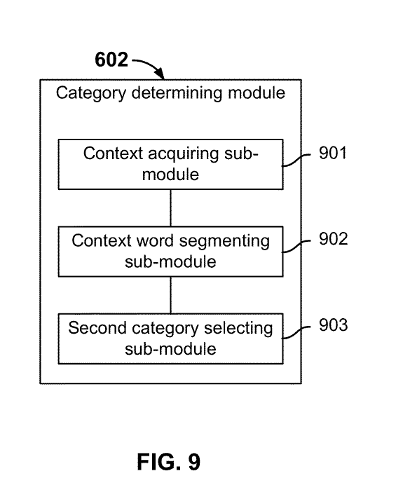

FIG. 9 is a diagram showing a third example of a category determining module. In some embodiments, category determining module 602 of system 600 of FIG. 6 is implemented using the example of FIG. 9. In the example, the category determining module includes context acquiring sub-module 901, context word segmenting sub-module 902, and second category selecting sub-module 903.

The sub-modules can be implemented as software components executing on one or more processors, as hardware such as programmable logic devices, and/or Application Specific Integrated Circuits designed to elements that can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The sub-modules may be implemented on a single device or distributed across multiple devices.

Context acquiring sub-module 901 is configured to obtain the context content associated with the selected piece of displayed content.

Context word segmenting module 902 is configured to perform word segmentation on the obtained context content to obtain individual words and phrases.

Second category selecting sub-module 903 is configured to use the segmented words/phrases to determine one or more target search categories.

FIG. 10 is a diagram showing an example of a results presenting module. In some embodiments, results presenting module 604 of system 600 of FIG. 6 is implemented using the example of FIG. 10. In the example, the results presenting module includes behavior acquiring sub-module 1001, second counting sub-module 1002, results selecting sub-module 1003, and information presenting sub-module 1004.

The sub-modules can be implemented as software components executing on one or more processors, as hardware such as programmable logic devices, and/or Application Specific Integrated Circuits designed to elements that can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The sub-modules may be implemented on a single device or distributed across multiple devices.

Behavior acquiring sub-module 1001 is configured to obtain user behavior data including recorded user operations in user search histories.

Second counting sub-module 1002 is configured to use the obtained user behavior data to count the number of user search operations with respect to each historical search result in each of the target search categories.

Results selecting sub-module 1003 is configured to select a number of search results to present in each target search category based on the count associated with historical search operations with respect to historical search results in that target search category.

Information presenting sub-module 1004 is configured to present the selected number of search results for each respective target search category in a section of the separate window that corresponds to that target search category.

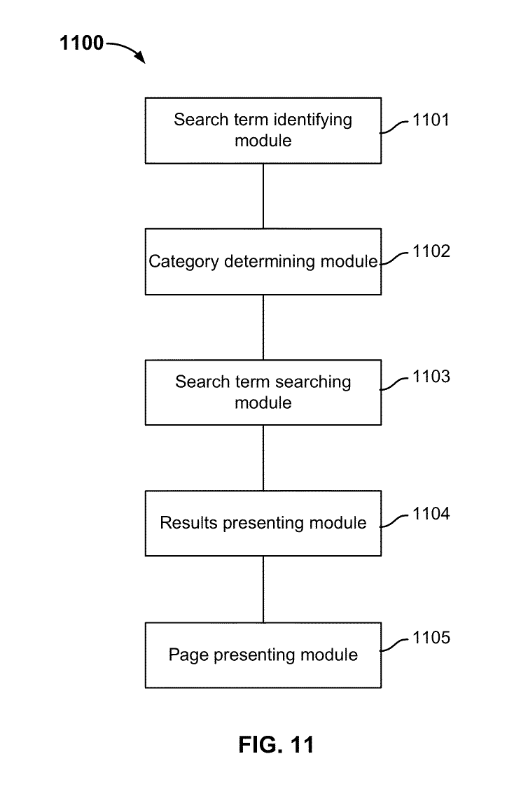

FIG. 11 is a diagram showing an embodiment of a system for providing search results corresponding to displayed content. In the example, system 1100 includes search term identifying module 1101, category determining module 1102, search term searching module 1103, results presenting module 1104, and page presenting module 1105.

The modules can be implemented as software components executing on one or more processors, as hardware such as programmable logic devices, and/or Application Specific Integrated Circuits designed to elements that can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices.

Search term identifying module 1101, category determining module 1102, search term searching module 1103, and results presenting module 1104 are implemented similarly to search term identifying module 601, category determining module 602, search term searching module 603, and results presenting module 604 of system 600 of FIG. 6.

Page presenting module 1105 is configured to present a search page in a new window (e.g., in a new tab) that includes additional search results for a target search category in response to a user selection of the section of the separate window associated with that target search category.

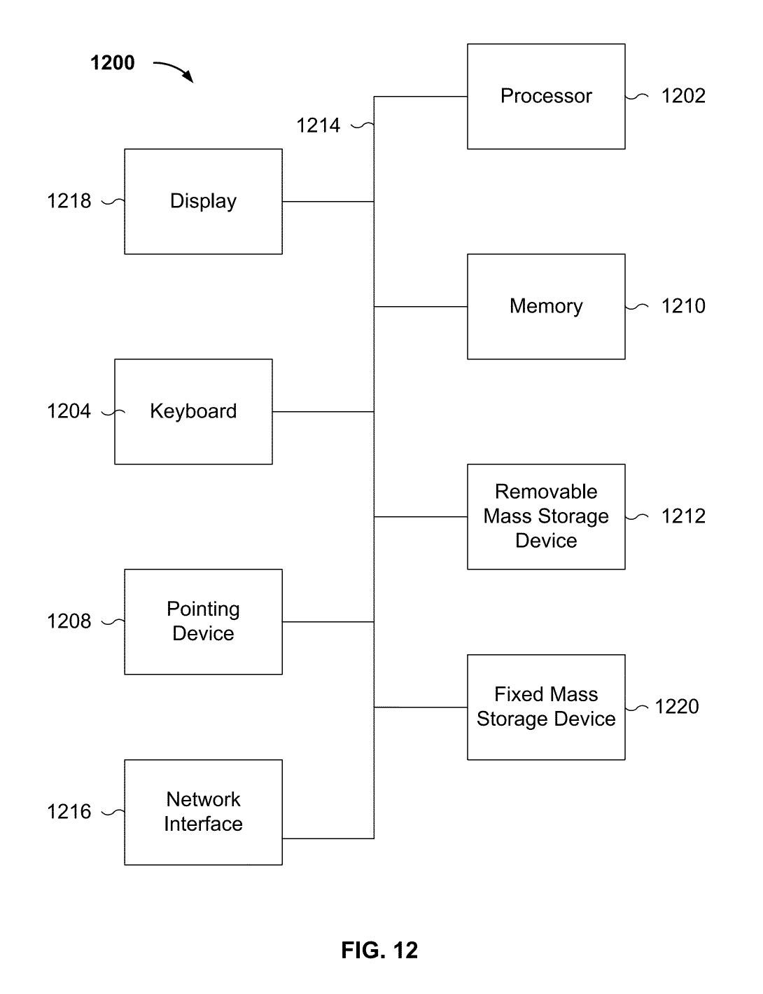

FIG. 12 is a functional diagram illustrating an embodiment of a programmed computer system for providing search results corresponding to displayed content. As will be apparent, other computer system architectures and configurations can be used to provide search results corresponding to displayed content. Computer system 1200, which includes various subsystems as described below, includes at least one microprocessor subsystem (also referred to as a processor or a central processing unit (CPU)) 1202. For example, processor 1202 can be implemented by a single-chip processor or by multiple processors. In some embodiments, processor 1202 is a general purpose digital processor that controls the operation of the computer system 1200. Using instructions retrieved from memory 1210, the processor 1202 controls the reception and manipulation of input data, and the output and display of data on output devices (e.g., display 1218). In some embodiments, processor 1202 includes and/or is used to provide search results corresponding to displayed content.

Processor 1202 is coupled bi-directionally with memory 1210, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1202. Also as is well known in the art, primary storage typically includes basic operating instructions, program code, data, and objects used by the processor 1202 to perform its functions (e.g., programmed instructions). For example, memory 1210 can include any suitable computer readable storage media, described below, depending on whether, for example, data access needs to be bi-directional or uni-directional. For example, processor 1202 can also directly and very rapidly retrieve and store frequently needed data in a cache memory (not shown).

A removable mass storage device 1212 provides additional data storage capacity for the computer system 1200 and is coupled either bi-directionally (read/write) or uni-directionally (read only) to processor 1202. For example, storage 1212 can also include computer readable media such as magnetic tape, flash memory, PC-CARDS, portable mass storage devices, holographic storage devices, and other storage devices. A fixed mass storage 1220 can also, for example, provide additional data storage capacity. The most common example of fixed mass storage 1220 is a hard disk drive. Mass storages 1212, 1220 generally store additional programming instructions, data, and the like that typically are not in active use by the processor 1202. It will be appreciated that the information retained within mass storages 1212 and 1220 can be incorporated, if needed, in standard fashion as part of memory 1210 (e.g., RAM) as virtual memory.

In addition to providing processor 1202 access to storage subsystems, bus 1214 can also be used to provide access to other subsystems and devices. As shown, these can include a display 1218, a network interface 1216, a keyboard 1204, and a pointing device 1208, as well as an auxiliary input/output device interface, a sound card, speakers, and other subsystems as needed. For example, the pointing device 1208 can be a mouse, stylus, track ball, or tablet, and is useful for interacting with a graphical user interface.

The network interface 1216 allows processor 1202 to be coupled to another computer, computer network, or telecommunications network using a network connection as shown. For example, through the network interface 1216, the processor 1202 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1202 can be used to connect the computer system 1200 to an external network and transfer data according to standard protocols. For example, various process embodiments disclosed herein can be executed on processor 1202, or can be performed across a network such as the Internet, intranet networks, or local area networks, in conjunction with a remote processor that shares a portion of the processing. Additional mass storage devices (not shown) can also be connected to processor 1202 through network interface 1216.

An auxiliary I/O device interface (not shown) can be used in conjunction with computer system 1200. The auxiliary I/O device interface can include general and customized interfaces that allow the processor 1202 to send and, more typically, receive data from other devices such as microphones, touch-sensitive displays, transducer card readers, tape readers, voice or handwriting recognizers, biometrics readers, cameras, portable mass storage devices, and other computers.

The description above is only a specific implementation of the present application. It should be pointed out that persons with ordinary skill in the art can, without departing from the principles of the present application, also produce a number of improvements and embellishments and that such improvements and embellishments should also be regarded as falling within the scope of protection of the present application.

In order that persons skilled in the art may have a better understanding of the solution of the present application, the technical solutions in the embodiments of the present application will be clearly and completely described in light of the drawings in specific embodiments of the present application. Obviously, the described embodiments are merely a part of the embodiments of the present application and not all the embodiments. All other embodiments obtained on the basis of the embodiments of the present application by persons with ordinary skill in the art shall fall within the scope of protection of the present application so long as no inventive effort is made in the course of obtaining them.

The present application can be used in many general purpose or specialized computer system environments or configurations. For example: personal computers, servers, hand-held devices or portable equipment, tablet type equipment, multiprocessor systems, microprocessor-based systems, set-top boxes, programmable consumer electronic equipment, networked PCs, minicomputers, mainframe computers, distributed computing environments that include any of the systems or equipment above, and so forth.

The present application can be described in the general context of computer executable commands executed by a computer, such as a program module. Generally, program modules include routines, programs, objects, components, data structures, etc. to execute specific tasks or achieve specific abstract data types. The present application can also be carried out in distributed computing environments; in such distributed computing environments, tasks are executed by remote processing equipment connected via communication networks. In distributed computing environments, program modules can be located on storage media at local or remote computers that include storage equipment.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
receive a search command associated with a selected piece of displayed content, wherein the displayed content is presented at a user interface;
determine a search query from the selected piece of displayed content;
determine a plurality of target search categories associated with the search query;
perform a respective search using the search query in each target search category of the plurality of target search categories to obtain a corresponding set of one or more search results; and
cause the corresponding set of one or more search results obtained for each target search category of the plurality of target search categories to be presented in a corresponding section associated with that target search category in a separate window at the user interface; and
one or more memories coupled to the one or more processors and configured to provide instructions for the one or more processors.

2. The system of claim 1, wherein the search command is generated in response to a detection of a predetermined operation at a client device.

3. The system of claim 1, wherein to determine the plurality of target search categories associated with the search query comprises to:
obtain historical user behavior data associated with a current searching user associated with the search command;
use the historical user behavior data to determine a respective number of search operations performed by the current searching user with respect to each of one or more search categories;
rank the one or more search categories based on their respective number of search operations performed by the current searching user; and
select a predetermined number of the ranked one or more search categories as the plurality of target search categories.

4. The system of claim 1, wherein to determine the plurality of target search categories associated with the search query comprises to:
obtain historical user behavior data associated with a plurality of users;
use the historical user behavior data to determine a respective number of search operations performed by the plurality of users with respect to each of one or more search categories;
rank the one or more search categories based on their respective number of search operations performed by the plurality of users; and
select a predetermined number of the ranked one or more search categories as the plurality of target search categories.

5. The system of claim 1, wherein to determine the plurality of target search categories associated with the search query comprises to:
determine preset search categories that are configured by a current searching user associated with the search command; and
use the preset search categories as the plurality of target search categories.

6. The system of claim 1, wherein to determine the plurality of target search categories associated with the search query comprises to:
determine context content relative to the selected piece of displayed content at the user interface;
segment the context content into a set of words or phrases; and
determine the plurality of target search categories based at least in part on the set of words or phrases.

7. The system of claim 1, wherein the one or more processors are further configured to:
receive a selection associated with a presented target search category in the separate window; and
cause additional search results associated with the presented target search category to be presented in a new window or a new tab.

8. The system of claim 1, wherein the one or more processors are further configured to:
receive a selection associated with a selected search result from a presented target search category in the separate window; and
cause a download to be performed with respect to content associated with the selected search result.

9. The system of claim 1, wherein to cause the corresponding set of one or more search results obtained for each target search category of the plurality of target search categories to be presented comprises to:
obtain historical user behavior data associated with a plurality of users;
use the historical user behavior data to determine a respective number of search operations performed by the plurality of users with respect to search results of each of the plurality of target search categories; and
determine a number of search results to be presented in each of the plurality of target search categories based at least in part on the determined respective number of search operations performed by the plurality of users with respect to the search results of each of the plurality of target search categories.

10. A method, comprising:
receiving a search command associated with a selected piece of displayed content, wherein the displayed content is presented at a user interface;
determining a search query from the selected piece of displayed content;
determining, using one or more processors, a plurality of target search categories associated with the search query;
performing a respective search using the search query in each target search category of the plurality of target search categories to obtain a corresponding set of one or more search results; and
causing the corresponding set of one or more search results obtained for each target search category of the plurality of target search categories to be presented in a corresponding section associated with that target search category in a separate window at the user interface.

11. The method of claim 10, wherein the search command is generated in response to a detection of a predetermined operation at a client device.

12. The method of claim 10, wherein determining the plurality of target search categories associated with the search query comprises:
obtaining historical user behavior data associated with a current searching user associated with the search command;
using the historical user behavior data to determine a respective number of search operations performed by the current searching user with respect to each of one or more search categories;
ranking the one or more search categories based on their respective number of search operations performed by the current searching user; and
selecting a predetermined number of the ranked one or more search categories as the plurality of target search categories.

13. The method of claim 10, wherein determining the plurality of target search categories associated with the search query comprises:
obtaining historical user behavior data associated with a plurality of users;
using the historical user behavior data to determine a respective number of search operations performed by the plurality of users with respect to each of one or more search categories;
ranking the one or more search categories based on their respective number of search operations performed by the plurality of users; and
selecting a predetermined number of the ranked one or more search categories as the plurality of target search categories.

14. The method of claim 10, wherein determining the plurality of target search categories associated with the search query comprises:
determining preset search categories that are configured by a current searching user associated with the search command; and
using the preset search categories as the plurality of target search categories.

15. The method of claim 10, wherein determining the plurality of target search categories associated with the search query comprises:
determining context content relative to the selected piece of displayed content at the user interface;
segmenting the context content into a set of words or phrases; and
determining the plurality of target search categories based at least in part on the set of words or phrases.

16. The method of claim 10, further comprising:
receiving a selection associated with a presented target search category in the separate window; and
causing additional search results associated with the presented target search category to be presented in a new window or a new tab.

17. The method of claim 10, further comprising:
receiving a selection associated with a selected search result from a presented target search category in the separate window; and
causing a download to be performed with respect to content associated with the selected search result.

18. The method of claim 10, wherein causing the corresponding set of one or more search results obtained for each target search category of the plurality of target search categories to be is presented comprises:
obtaining historical user behavior data associated with a plurality of users;
using the historical user behavior data to determine a respective number of search operations performed by the plurality of users with respect to search results of each of the plurality of target search categories; and
determining a number of search results to be presented in each of the plurality of target search categories based at least in part on the determined respective number of search operations performed by the plurality of users with respect to the search results of each of the plurality of target search categories.

19. A computer program product, the computer program product being embodied in a non-transitory computer readable storage medium and comprising computer instructions for:
receiving a search command associated with a selected piece of displayed content, wherein the displayed content is presented at a user interface;
determining a search query from the selected piece of displayed content;
determining a plurality of target search categories associated with the search query;
performing a respective search using the search query in each target search category of the plurality of target search categories to obtain a corresponding set of one or more search results; and
causing the corresponding set of one or more search results obtained for each target search category of the plurality of target search categories to be presented in a corresponding section associated with that target search category in a separate window at the user interface.
